(19) United States
(12) Patent Application Publication
(10) Pub. No.: US 2014/0163782 A1
(43) Pub. Date: Jun. 12, 2014

(54) Aircraft data management system

(71) Applicant: THALES, Neuilly-sur-Seine (FR)

(72) Inventors: Remi HUYNH, Toulouse (FR); Stephanie PEYRAT, Toulouse (FR); Francois FOURNIER, Roques Sur Garonne (FR)

(21) Appl. No.: 14/088,255

(22) Filed: Nov. 22, 2013

(30) Foreign Application Priority Data
Nov. 23, 2012 (FR) 12 03153

(51) Int. Cl. B64C 19/00

(52) U.S. Cl. CPC B64C 19/00
USPC 701/3

(57) ABSTRACT

An aircraft data management system comprises a first storage device for data representative of operating parameters of the aircraft, the first device being situated on the ground, and second storage device for data representative of parameters of said aircraft, the second device being embedded onboard said aircraft. The system also comprises a device for accessing the data contained in said first and second storage devices. The system also comprises a device for determining the stopping of the aircraft on the ground, a device for synchronizing the data contained in the first and second storage devices, according to information from the determination device. Furthermore, the access device also being designed to select the first or the second storage device to access the data, according to the information from the determination device authenticate a user accessing the data.

The present invention relates to a system for managing, broadcasting and synchronizing data associated with a civil or military aircraft. These data are generally general flight data (flight origin, flight destination, flight schedules, etc.), maintenance data (faults that have been detected, past failures of the aircraft, alerts, repairs that the aircraft has undergone, software downloaded to the aircraft, etc.). These data also cover the data relating to the supervision of the aircraft on stopovers (quantity of fuel loaded, deicing of the various aircraft elements, etc.), flight management data (in particular the flight plan, the maps loaded in the aircraft), or even data relating to the cabin (in particular details on the passengers and the data intended for the passengers via the cabin equipment, in particular the characteristics of the video and Internet data).

Computer equipment that can process some of these data is known in the prior art. There is in particular an equipment item known as electronic flight bag (EFB), which enables the pilot to have access to some of these data. There is also an equipment item known as portable maintenance access terminal (PMAT), which enables the maintenance operators, the cabin operators or the runway operators to perform maintenance on the aircraft. However, the current systems raise a problem of synchronizing and updating the data. In particular, there is no unified synchronization between the data stored onboard the aircraft and the data stored on the ground, nor is there any sharing of information between the different equipment items. In practice, depending on the phases of use of the aircraft, the data may be processed by users present onboard the aircraft, users present on the ground in proximity to the aircraft or else users present on the ground in control centers.

The present invention therefore aims to remedy these problems by proposing a system for managing, broadcasting and synchronizing all the data, giving the users access to the most up-to-date data possible, regardless of the phase of use of the aircraft.

Thus, there is proposed, according to one aspect of the invention, an aircraft data management system comprising a first storage device for data representative of operating parameters of the aircraft, the first device being situated on the ground. The system also comprises a second storage device for data representative of parameters of the aircraft, the second device being embedded onboard the aircraft, and a device for accessing the data contained in the first and second storage devices. The system also comprises a device for determining the stopping of said aircraft on the ground, a device for synchronizing the data contained in the first and second storage devices, according to information from the determination device. Furthermore, the access device is also designed to select the first storage device or the second storage device to access the data, according to the information from the determination device.

The presence of a synchronization device implies a two-way exchange between the first and second storage devices.

In some cases, the two bases are not synchronized permanently because of a break in connectivity because:
the airport where the aircraft is located is not necessarily equipped with connectivity, or else the public networks at the airport may be congested,
some aircraft are not equipped with in-flight connectivity means,
in-flight connectivity is not available in certain areas,
the cost of communication in certain areas is sometimes not acceptable for the synchronization of certain data.

In this case it is therefore necessary to select the base (ground or embedded in the aircraft) on which the operator will work, according to a context which includes:
the fact that the aircraft is on the ground or in flight (this is determined based in particular on the compression of the landing gear, the opening or not of a door or else the fact that the parking brake of the aircraft is activated),
the geolocation of the aircraft,
the communication policy of the airline according to the position of the aircraft and agreements with the telecommunications operators,
the flight phase,
the availability of the communication means and
the state of synchronization of the two bases.

Advantageously, said access device is designed to select said first storage device if:
said aircraft is on the ground and
said first and second storage devices are linked together and
said first and second storage devices have been synchronized.

Advantageously, said access device is designed to select said second storage device if:
said aircraft is in flight or
said first and second storage devices are not linked together or
said first and second storage devices have not been synchronized.

Advantageously, the determination device is designed to make this determination from information representative of a compression of a landing gear and/or of an activation/deactivation of a parking brake of the aircraft and/or of an opening/closing of a door of the aircraft.

Advantageously, the aircraft is considered to be stopped on the ground by the determination device if one of the following conditions is fulfilled:
a landing gear has been compressed for a given time,
a landing gear is compressed and a parking brake is activated,
a landing gear is compressed and a door is open,
a parking brake is activated and a door is open.

According to one technical feature, the access device comprises an interface of web services type.

An interface of web service type is an interface that allows data to be communicated and exchanged between multivendor applications and systems in distributed environments. It is therefore a set of functionalities sharing data via a computer network, by and for applications or machines, without human intervention, and synchronously.

These interfaces of web service type therefore make it possible to interlink multivendor hardware (for example EFB, PMAT, generic computer, generic tablets and smart phones).

Advantageously, the system comprises a device for managing authorization to access the data contained in the first storage device or the second storage device.

Advantageously, the access device also being designed to authenticate a user accessing the data.

The invention will be better understood and other advantages will become apparent on reading the detailed description given as a nonlimiting example and with the help of the figures in which:

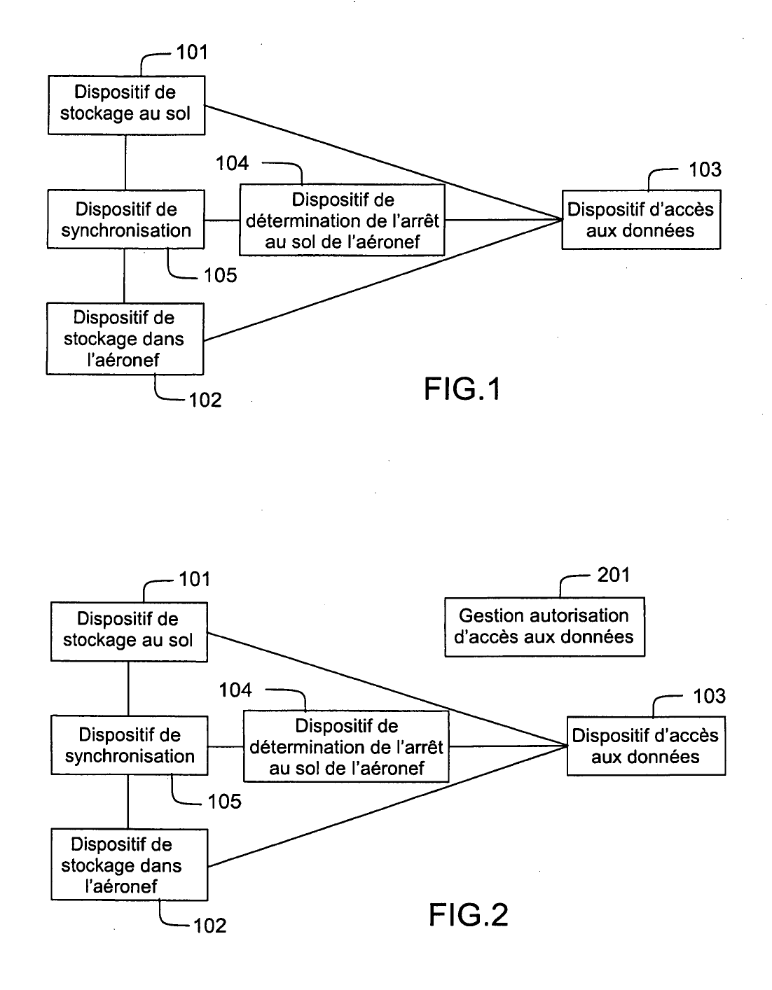

FIG. 1 shows the system according to a first aspect of the invention

FIG. 2 shows the system according to a second aspect of the invention.

The system as presented in FIG. 1 therefore comprises a first data storage device embedded in the aircraft 101 and a second data storage device on the ground 102. These storage devices are, for example, servers present in the control centers of an airline or else data centers present on the premises of a supplier of the airline. The embedded devices concentrate only the information of an aircraft whereas the devices on the ground concentrate the information from a set of aircraft. Such information that is likely to be stored comprises, for example:
the supervision of the aircraft on stopover (quantity of fuel loaded, deicing of the various elements of the aircraft, etc.)
the flight management data (in particular the flight plan, the maps loaded in the aircraft),
the data concerning the cabin (in particular the details on the passengers and the data intended for the passengers via the cabin equipment, in particular the characteristics of the video and Internet data),
the data relating to the pilots (flight plans, maps, performance calculations, etc.).

The system also comprises a device 103 allowing access to the data contained in the first or the second storage device. The choice of access to the first or second storage device is made according to information originating from the device 104 for determining the stopping of the aircraft on the ground.

Thus, when the aircraft is in flight, access to the data is made directly via the first storage device embedded in the aircraft.

When the aircraft is on the ground (event detected via the determination device 104), access to the data is made via the second storage device on the ground.

Different types of terminals can access the data via the access device. These terminals use an environment of client-server type. The client-server environment designates a mode of communication via a network between a plurality of programs or software packages: one, called client, sends requests; the other, or the others, called servers, await requests from the clients and respond to them. In the context of this invention, multivendor clients (for example EFB, PMAT, generic computer, generic tablets and smart phones) are used by the pilots, the maintenance operators, the cabin personnel or the personnel in charge of maintenance. Such equipment can use different operating systems, for example Windows, iOS or Android. These different terminals can belong to the airline responsible for operating the aircraft, to another airline or to a subcontractor of the airline. The interface between these terminals and the access device can use an open application programming interface, based for example on a technology of web services type. These web services allow for a computerized exchange of data. Furthermore, this access to the data is made securely, in particular through the authentication of the user.

The system finally comprises a synchronization device 105 which allows the synchronization between the data contained in the first storage device and the data contained in the second storage device. This synchronization is performed according to the information originating from the device 104 for determining the stopping of an aircraft on the ground.

In one embodiment, the device for determining the stopping of the aircraft on the ground makes this determination from the knowledge of the compression of the landing gear, of the activation/deactivation of the parking brake and/or of the opening/closing of the door or doors of the cabin.

According to these different parameters, a number of rules may exist for determining whether the aircraft is stopped on the ground. For example, it is possible to consider that:
if the landing gear has been compressed for a given time,
if the landing gear is compressed and the parking brake is activated,
if the landing gear is compressed and the door is open,
if the parking brake is activated and the door is open, then the aircraft is on the ground.

The device 103 allowing access to the data uses the data contained in the first storage device or the second storage device according to the following different rules. In particular, the data access device 103 is considered to use the first storage device embedded in the aircraft in the case where:
the aircraft is in flight,
if the connection with the second storage device on the ground is not available or
if the first storage device in the aircraft and the second storage device on the ground have not been synchronized.

The data access device 103 is considered to use the second storage device on the ground in the case where:
the aircraft is on the ground and the connection between the first and the second storage devices is set up,
and only if the first and the second storage devices have been synchronized.

The synchronization device 105 also uses the information supplied by the device 104 for determining the stopping of the aircraft on the ground. Thus, the synchronization is performed when the aircraft is stopped on the ground and when the connection between the first storage device in the aircraft and the second storage device on the ground is made.

FIG. 2 shows the invention in an embodiment in which it also comprises a device 201 for managing authorization to access the data.

This authorization management device is placed on the ground and is linked with the second data storage device on the ground. This link enables the authorization management device to indicate to the second data storage device on the ground the data that each user has the right to access. In order to perform the data exchanges, an encryption of the data, a public key type architecture or a secure environment for mobile applications can be used.

In one embodiment, the different devices are located in the following places:
the first storage device 101: in a building of the airline or in a building of the supplier of the solution or in the data center of a third party service provider,
the second storage device 102: in the cockpit or in the avionics bay,
the data access device 103: in the cockpit, in the cabin, around the aircraft or in a building of the airline or in a building of the supplier of the solution or in any place with Internet connection,
the device for determining stopping on the ground 104: in the cockpit or in the avionics bay,
the synchronization device 105: in the cockpit or in the avionics bay,
the device for managing authorization to access the data 201: in a building of the airline or in a building of the supplier of the solution or in any place with Internet connection.

1. An aircraft data management system comprising:
a first storage device for data representative of operating parameters of said aircraft, said first device being situated on the ground,
a second storage device for data representative of parameters of said aircraft, said second device being embedded onboard said aircraft,
a device for accessing the data contained in said first and second storage devices,
a device for determining the stopping of said aircraft on the ground,
a device for synchronizing the data contained in said first and second storage devices, according to information from said determination device;
said access device also being designed to:
select said first storage device or said second storage device to access the data, according to said information from said determination device.

2. The system according to claim 1, in which said access device is designed to select said first storage device if:
said aircraft is on the ground and
said first and second storage devices are linked together and
if said first and second storage devices have been synchronized.

3. The system according to claim 1, in which said access device is designed to select said second storage device if:
said aircraft is in flight or
said first and second storage devices are not linked together or
if said first and second storage devices have not been synchronized.

4. The system according to claim 1, in which said determination device is designed to make this determination from information representative of a compression of a landing gear and/or of an activation/deactivation of a parking brake of said aircraft and/or of an opening/closing of a door of said aircraft.

5. The system according to claim 1, in which said aircraft is considered to be stopped on the ground by said determination device if one of the following conditions is fulfilled:
a landing gear has been compressed for a given time,
a landing gear is compressed and a parking brake is activated,
a landing gear is compressed and a door is open,
a parking brake is activated and a door is open.

6. The system according to claim 1, in which said access device comprises an interface of web services type.

7. The system according to claim 1, also comprising a device for managing an authorization to access the data contained in said first storage device or second storage device.

8. The system according to claim 1, in which said access device is configured to authenticate a user accessing the data.
